(19) United States
(12) Patent Application Publication
(10) Pub. No.: US 2010/0268752 A1
(43) Pub. Date: Oct. 21, 2010

(54) APPARATUS AND METHOD FOR ESTIMATING HIGH-INTEGRATION, HIGH-SPEED AND PIPELINED RECURSIVE LEAST SQUARES

(75) Inventors: Dong Kyoo Kim, Daejeon (KR); Jae Young Kim, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/747,599

(22) PCT Filed: May 16, 2008
(86) PCT No.: PCT/KR08/02758

§ 371 Date: Jun. 11, 2010

(30) Foreign Application Priority Data
Dec. 12, 2007 (KR) 10-2007-0128941

(51) Int. Cl. G06F 17/10; H04B 1/10

(52) U.S. Cl. 708/320; 375/346

(57) ABSTRACT

Provided is an apparatus and method for estimating high-integration, high-speed and pipelined RLSs. Pipeline characteristics are given to an RLS algorithm to provide a high-speed HIP-RLS estimation apparatus. The HIP-RLS estimation apparatus has higher integration level than a conventional CORDIC-based RLS estimation apparatus. Thus, the use of the HIP-RLS estimation apparatus can reduce a chip size, thereby making it possible to fabricate more chips using the same wafer. Also, the HIP-RLS estimation apparatus is suitable for high-speed wireless communication because it has a high signal processing speed.

### TECHNICAL FIELD

The present disclosure relates to an apparatus and method for estimating high-integration, high-speed and pipelined Recursive Least Squares (RLSs), and more particularly, to an apparatus and method for estimating high-integration, high-speed and pipelined RLSs, which can provide a high integration level and a high signal processing speed by giving pipeline features to an RLS algorithm.

This work was supported by the IT R&D program of MIC/IITA. [2006-S-070-02, Development of Cognitive Wireless Home Networking System]

### BACKGROUND ART

The importance of broadband wireless communication technologies is increasing to support high-speed and high-quality wireless communication services. In the case of broadband wireless channels, frequency-selective fading may occur in various forms over a wide band, which may increase signal distortion and reduce wireless communication qualities.

To prevent such problems, a receiver of a system using broadband wireless channels uses a channel equalizer for compensating for frequency-selective fading.

Such a channel equalizer is used in connection with a channel estimator for determining filter coefficients for minimization of an output error in the channel equalizer.

Channel equalizers are broadly classified into a single carrier-based channel equalizer and an Orthogonal Frequency Division Multiplexing (OFDM)-based channel equalizer.

The OFDM-based channel equalizer needs a relatively-simple channel estimator structure because it has a relatively-simple one-tap equalizer structure.

However, the OFDM-based channel equalizer may have the problem related to inter-subchannel orthogonality restoration, which can be solved by acquiring accurate synchronization between a transmitter and a receiver, and the problem related to a Peak-to-Average Ratio (PAR), which can be solved by using high-price high-performance analog components.

On the other hand, the single carrier-based channel equalizer needs a somewhat-complex channel estimator structure, but has high frequency efficiency and a small PAR, thereby making it possible to implement a low-price receiver.

In detail, the single carrier-based channel equalizer wherein the synchronization technology of a receiver is simple, can provide a certain level of performance by using a low-price amplifier and a low-resolution Analog-to-Digital Converter (ADC) and Digital-to-Analog Converter (DAC).

Channel estimators interlinked with the single carrier-based channel equalizer are broadly classified into a Least Mean Square (LMS)-based channel estimator and a Recursive Least Square (RLS)-based channel estimator.

Assuming that channel the estimators have the same order of n, the LMS-based channel estimator has a computational complexity of O(n) and the RLS-based channel estimator has a computational complexity of

O(n²)

so that the LMS-based channel estimator relatively has lower computational complexity than the RLS-based channel estimator.

However, the LMS-based channel estimator has low performance so that it is unsuitable for compensating for the frequency-selective fading of broadband wireless channels. Therefore, the RLS-based channel estimator is mainly used as a channel estimator interlinked with the single-carrier broadband wireless equalizer.

When an equalizer order is n, a conventional COordinate Rotation DIgital Computer (CORDIC)-based RLS channel estimator needs the

(n+1)*(n+2)/2−1

number of CORDICs and the

(n−1)*n/2

number of multipliers. In other words, the conventional CORDIC-based RLS channel estimator needs so many elements, in comparison with the equalizer order.

That is, because the conventional CORDIC-based RLS channel estimator has very high area complexity, it is rather difficult to apply to high-order broadband wireless communication systems.

### DISCLOSURE OF INVENTION

### Technical Problem

Therefore, an object of the present invention is to provide an apparatus and method for estimating high-integration, high-speed and pipelined RLSs, which can provide a high integration level by applying an equation development technique without duplicate computation to the computation of the filter coefficients of a channel equalizer.

Another object of the present invention is to provide an apparatus and method for estimating high-integration, high-speed and pipelined RLSs, which can provide a high signal processing speed by giving pipeline features to a conventional RLS algorithm.

### Technical Solution

To achieve these and other advantages and in accordance with the purpose(s) of the present invention as embodied and broadly described herein, an apparatus for estimating high-integration, high-speed and pipelined RLSs in accordance with an aspect of the present invention includes: a first block for outputting an estimation error signal, a second internal signal and a third internal signal based on a first internal signal, a reference signal, an observed signal and an equalizer output signal received from the outside; a second block for generating a fourth internal signal based on the observed signal and the second internal signal output from the first block; a third block for updating an equalizer filter coefficient based on the estimation error signal output from the first block and the fourth internal signal output from the second block; and a fourth block for updating the first internal signal based on the third internal signal output from the first block and the fourth internal signal output from the second block, wherein the first through fourth internal signals are calculated through an RLS algorithm having a connection structure without a duplicate operation.

To achieve these and other advantages and in accordance with the purpose(s) of the present invention, a method for estimating high-integration, high-speed and pipelined RLSs in accordance with another aspect of the present invention includes: externally receiving a reference signal, an observed signal and an equalizer output signal from the outside; outputting an estimation error signal, a second internal signal and a third internal signal based on the first internal signal, the reference signal, the observed signal and the equalizer output signal; outputting a fourth internal signal based on the observed signal and the second internal signal; updating an equalizer filter coefficient based on the estimation error signal and the fourth internal signal; and updating the first internal signal based on the third internal signal and the fourth internal signal.

To achieve these and other advantages and in accordance with the purpose(s) of the present invention, a method for estimating a wireless signal in accordance with another aspect of the present invention includes: modeling a signal estimation scheme to extract an algorithm; removing duplication from the algorithm; converting the duplication-removed algorithm into one or more modules; extracting a correlation between the modules to define a calculation order; and performing calculations for the respective modules according to the defined calculation order.

The foregoing and other objects, features, aspects and advantages of the present invention will become more apparent from the following detailed description of the present invention when taken in conjunction with the accompanying drawings.

### ADVANTAGEOUS EFFECTS

The apparatus and method for estimating high-integration, high-speed and pipelined RLSs according to the present invention can increase a chip integration level by applying an equation development technique without duplicate computation to the computation of the filter coefficients of a single carrier-based channel equalizer.

Also, the apparatus and method for estimating high-integration, high-speed and pipelined RLSs according to the present invention can increase a signal processing speed by giving pipeline features to a conventional RLS algorithm.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram of an HIP-RLS estimation apparatus according to an embodiment of the present invention;

FIGS. 2 and 3 are block diagrams of filters in a DFE according to an embodiment of the present invention;

FIGS. 4 and 5 are block diagrams of a first block according to an embodiment of the present invention;

FIGS. 6 and 7 are block diagrams of a fourth block according to an embodiment of the present invention;

FIG. 8 is a block diagram of a memory module according to an embodiment of the present invention;

FIG. 9 is a flowchart illustrating an operation of the HIP-RLS estimation apparatus according to an embodiment of the present invention;

FIG. 10 is a waveform diagram of the HIP-RLS estimation apparatus according to an embodiment of the present invention; and

FIG. 11 is a flowchart illustrating a method for estimating a wireless signal according to an embodiment of the present invention.

### BEST MODE FOR CARRYING OUT THE INVENTION

The present invention is intended to provide an RLS-based channel estimation apparatus that can minimize a chip size and a chip fabrication cost by minimizing the area complexity, can remove the duplicity of the conventional RLS algorithm, and can perform the computational steps in a pipeline fashion.

Hereinafter, specific embodiments will be described in detail with reference to the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art.

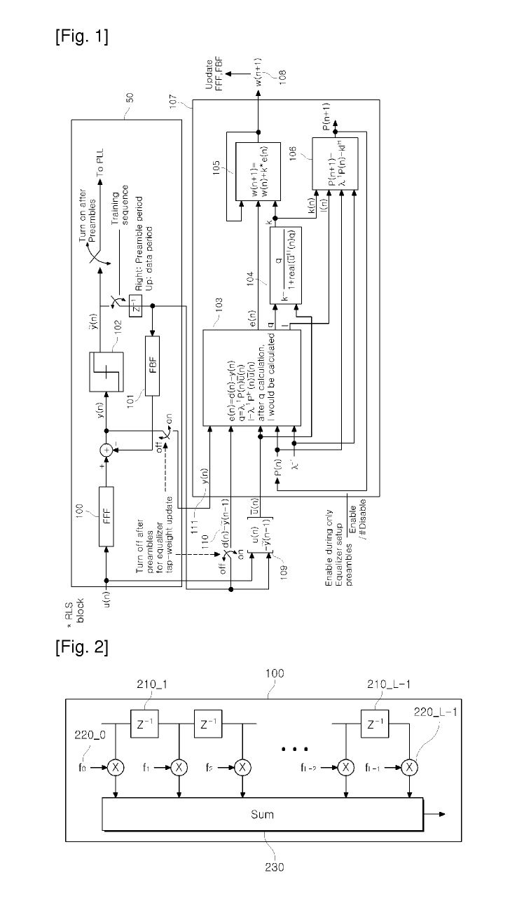

FIG. 1 is a block diagram of a high-integration, high-speed and pipelined RLS estimation apparatus (hereinafter referred to as an HIP-RLS estimation apparatus) according to an embodiment of the present invention.

Referring to FIG. 1, an HIP-RLS estimation apparatus 107 includes: a first block 103 for outputting an estimation error signal e(n), a second internal signal q(n), and a third internal signal l(n) on the basis of an external equalizer output signal y(n), a reference signal d(n), an observed signal

ū(n),

and a first internal signal P(n); a second block 104 for generating a fourth internal signal k(n) on the basis of the second internal signal q(n) and the observed signal

ū(n);

a third block 105 for updating a equalizer filter coefficient w(n) on the basis of the estimation error signal e(n) and the fourth internal signal k(n); and a fourth block 106 for updating the first internal signal P(n) on the basis of the third internal signal l(n) and the fourth internal signal k(n).

The HIP-RLS estimation apparatus 107 updates the current equalizer filter coefficient w(n) on the basis of an observed signal 109, a reference signal d(n) 110 and an output signal y(n) 111 of a decision feedback equalizer (DFE) 50, and then outputs the next equalizer filter coefficient w(n+1) 108.

The first block 103 receives the external equalizer output signal y(n), a reference signal

d(n)=\tilde{y}(n−1),

and an observed signal

$$\overline{u} ( n ) = ⌈ \begin{matrix}u ( n ) \\ - \tilde{y} ( n - 1 )\end{matrix} ⌉ ,$$

of a received signal u(n) and the reference signal, and outputs the estimation error signal e(n), the second internal signal q(n), and the third internal signal l(n) on the basis of the first internal signal P(n).

Herein, an initial value P(0) of the first internal signal P(n) is calculated as the following Equation (1).

P(0)=δ⁻¹×1 (Equation 1)

The N number of n^{th} q signals q(n) and the N number of n^{th} l signal l(n), where N is the order of the estimation apparatus (0≦n≦N−1), are calculated as the following Equation (2).

q=λ⁻¹P(n)ū(n)

I=λ⁻¹P^{H}(n)ū(n) (Equation 2)

where l is a unit matrix having the same size as the first internal signal P(n), δ is a predetermined number (e.g., 0.001), and λ is a predetermined forgetting factor that may be a constant of from 0.9 to 1.0.

In Equation (2), multiplication of λ⁻¹ may be implemented by bit shift.

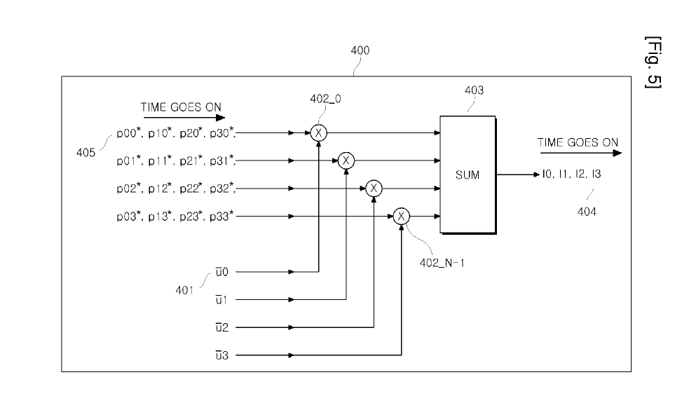

The detailed elements of the first block 103 will be described later with reference to FIGS. 4 and 5.

Using the following Equation (3), the second block 104 generates the fourth internal signal k(n) on the basis of the first internal signal P(n) output from the first block 103.

$$k = \frac{q}{1 + real ( {\overline{u}}^{H} ( n ) q )} \qquad ( Equation 3 )$$

Using the following Equation (4), the third block 105 updates the current equalizer filter coefficient w(n) on the basis of the estimation error signal e(n) and the fourth internal signal k(n) output respectively from the first block 103 and the second block 104, to output the next equalizer filter coefficient w(n+1).

w(n+1)=w(n)+k*e(n) (Equation 4)

Herein, an initial value w(0) of the equalizer filter coefficient is calculated as the following Equation (5).

w(0)=[00 . . . 0]^{T} (Equation 5)

Using the following Equation (6), the fourth block 106 updates the first internal signal P(n) on the basis of the third internal signal l(n) and the fourth internal signal k(n) output respectively from the first block 103 and the second block 104, to generate the updated first internal signal P(n+1).

P(n+1)=λ⁻¹P(n)−kl^{H} (Equation 6)

The DFE 50 includes a feedforward filter (FFF) 100, a feedback filter (FBF) 101, and a slicer 102 to compensate for distortion caused by amplification or transmission.

The FFF 100/the FBF 101 is an internal feedforward filter/feedback filter of the equalizer for the error detection/compensation of an RX signal.

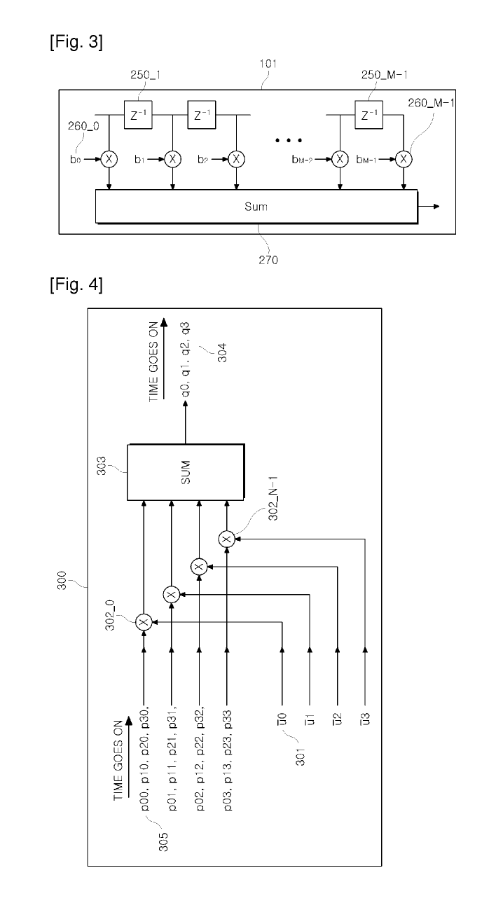

The detailed constructions of the FFF 100 and the FBF 101 will be described later with reference to FIGS. 2 and 3.

The slicer 102 (i.e., a decision device) receives an output signal y(n) of the DFE 50, and converts the signal into a signal

\tilde{y}(n)

determined according to a predetermined amplitude and phase.

For example, assuming that the received signal y(n) is a 2-bit digital signal, the slicer 102 may output ‘0’ if the size of the received signal y(n) is equal to or smaller than 10 B (a binary number), and may output ‘1’ if the size of the received signal y(n) is larger than 10 B.

Although FIG. 1 illustrates a case where the HIP-RLS estimation apparatus 107 operates in connection with the DFE 50, the HIP-RLS estimation apparatus 107 may operation in connection with a linear equalizer.

FIGS. 2 and 3 are block diagrams of the filters in the DFE 50 according to an embodiment of the present invention. FIG. 2 illustrates the FFF 100, and FIG. 3 illustrates the FBF 101.

Referring to FIG. 2, the FFF 100 is a feedforward filter of the equalizer, and includes L multipliers 220_0˜220_L−1, (L−1) delayers 210_1˜210-L−1, and at least one adder 230.

The m^{th} multiplier 220_m of the FFF 100 outputs the product of an equalizer filter coefficient fm and a signal u(n), which is delayed by m times by the delayers 210_1˜210_L−1, to the adder 230.

The adder 230 receives the outputs of the multipliers 220_0˜220_L−1, and outputs the sum of the outputs of the multipliers 220_0˜220_L−1.

Referring to FIG. 3, the FBF 101 is a feedback filter of the equalizer, and includes M multipliers 260_0˜260_M−1, (M−1) delayers 250_1˜250_M−1, and at least one adder 270.

The m^{th} multiplier 260_m of the FBF 101 outputs the product of an equalizer filter coefficient fm and a signal u(n), which is delayed by m times by the delayers 250_1˜210_M−1, to the adder 270.

The adder 270 receives the outputs of the multipliers 250_0˜250_M−1, and outputs the sum of the outputs of the multipliers 250_0˜250_L−1.

Herein,

e(n)=[f₀, . . . , f_{L-1, b}₀, . . . , b_{M-1}],

L is the order of the FFF(100), M is the order of the FBF(101), and N is the sum of L and M.

FIGS. 4 and 5 are block diagrams of the first block 103 according to an embodiment of the present invention.

Referring to FIGS. 4 and 5, the first block 103 includes a second internal signal generator 300 and a third internal signal generator 400 for respectively generating a second internal signal and a third internal signal based on a first internal signal and an observed signal.

The second internal signal generator 300 includes: a plurality of multipliers 302_0˜302_N−1 for multiplying a plurality of sequentially-input first internal signals by observed signals of the corresponding orders; and at least one adder 303 for summing the outputs of the multipliers 302_0˜302_N−1 to output the resulting signals sequentially.

The second internal signal generator 300 generates the second internal signal by multiplying the bit-shift result of the output of the adder 303 by a predetermined forgetting factor λ⁻¹ as shown in Equation (2).

The third internal signal generator 400 includes: a plurality of multipliers 402_0˜402_N−1 for multiplying a plurality of sequentially-input first internal signals by observed signals of the corresponding orders; and at least one adder 403 for summing the outputs of the multipliers 402_0˜402_N−1 to output the resulting signals sequentially.

The third internal signal generator 400 generates the third internal signal by multiplying the bit-shift result of the output of the adder 403 by a predetermined forgetting factor -¹ as shown in Equation (2).

Also, the first block 103 generates an estimation error signal by subtracting a reference signal from an output signal of the equalizer.

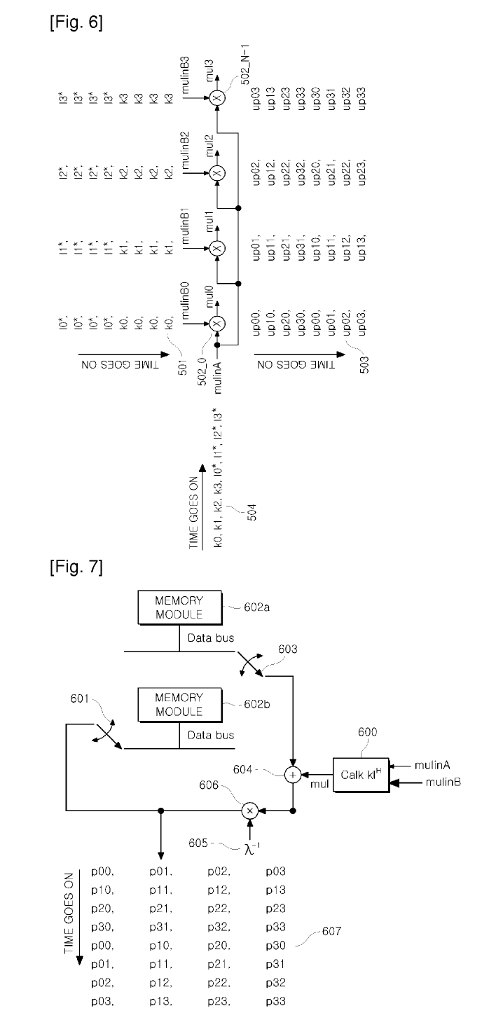

FIGS. 6 and 7 are block diagrams of the fourth block 106 according to an embodiment of the present invention. FIG. 6 illustrates a Hermite operation unit 500, and FIG. 7 illustrates the fourth block 106.

Referring to FIGS. 6 and 7, the fourth block 106 includes: memory modules 602a and 602b for storing the first internal signals; a multiplier 606 for multiplying the current first internal signal output from the memory modules 602a and 602b by the forgetting factor; an Hermite operation unit 500 for multiplying the fourth internal signal by the Hermite transform value of the third internal signal; and an adder 604 for subtracting an output value of the Hermite operation unit 500 from an output value of the multiplier 606.

Herein, the output of the adder 604 is the updated first internal signal.

The memory modules 602a and 602b include at least two band memories to perform selective input/output in a switching configuration.

Herein, the first bank memory stores the current first internal signal P(n) and the second bank memory stores the updated first internal signal P(n+1).

The fourth block 106 further includes at least two switches 601 and 603 that are connected to at least two bank memories 602a and 602b to form the selective storage path of the current first internal signal P(n) and the updated first internal signal P(n+1).

The Hermite operation unit 500 includes a plurality of multipliers 502_0˜502_N−1 that respectively multiply the sequentially-input fourth internal signals 504 by the Hermite transform values 501 of the third internal signals to output the resulting signals sequentially.

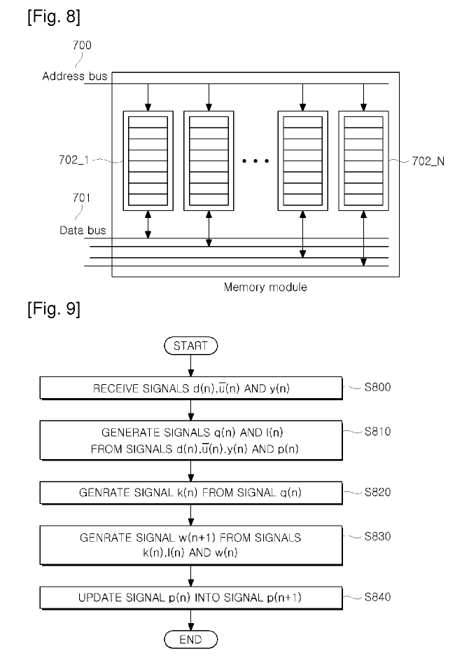

FIG. 8 is a block diagram of the memory modules 602a and 602b according to an embodiment of the present invention.

Referring to FIG. 8, the memory modules 602a and 602b are parallel-structure bank memories 702 that share an address bus 700 and a data bus 701.

The bank memory 702 is divided into as many banks as the order (N) of the estimation apparatus. For example, if the order of the estimation apparatus is 4, the bank memory 702 has four banks.

Meanwhile, the first block 103, the second block 104, the third block 105, and the fourth block 106 perform their operations in units of symbol time of the received signal u(n) input to the equalizer.

Also, the first block 103, the second block 104, the third block 105, and the fourth block 106 calculate the first through fourth internal signals through an RLS algorithm having a connection structure without a duplicate operation.

FIG. 9 is a flowchart illustrating an operation of the HIP-RLS estimation apparatus 107 according to an embodiment of the present invention.

Referring to FIG. 9, in operation S800, the HIP-RLS estimation apparatus 107 receives an equalizer output signal, a reference signal, and an observed signal from the outside.

In operation S810, based on the external signals and the internal first internal signal, the HIP-RLS estimation apparatus 107 outputs an estimation error signal, the second internal signal, and the third internal signal.

Herein, a signal P(n) updated from the current first internal signal is calculated using Equation (6), and the estimation error signal is generated by subtraction of the reference signal from the output signal.

The second internal signal and the third internal signal are calculated using Equation (2).

Herein, the second internal signal may be generated by summing the products of the sequential first internal signals and the observed signals of the corresponding orders and applying the predetermined forgetting factor to the summing result.

The third internal signal may be generated by summing the products of the conjugate complex numbers of the sequential first internal signals and the observed signals of the corresponding orders and applying the predetermined forgetting factor to the summing result.

In operation S820, based on the second internal signal and the observed signal, the HIP-RLS estimation apparatus 107 outputs the fourth internal signal calculated by Equation (3).

In operation S830, based on the estimation error signal and the fourth internal signal, the HIP-RLS estimation apparatus 107 outputs an updated equalizer filter coefficient signal w(n+1) calculated by Equation (4).

Herein, it is preferable that the equalizer filter coefficient signal w(n+1) is generated with a delay of 1 unit time from a signal K(n+1).

In operation S840, simultaneously with the output of the signal w(n+1), the HIP-RLS estimation apparatus 107 generates a signal P(n+1) (i.e., an updated P(n) signal) calculated by Equation (6).

For example, the first internal signal is updated by subtracting the Hermite transform value of the third internal signal by the fourth internal signal from the product of the current first internal signal of the forgetting factor.

Thereafter, the signal P(n+1) may be used to generate the next second through fourth internal signals and the next equalizer filter coefficient w(N+2).

Meanwhile, the HIP-RLS estimation apparatus 107 repeats the above operations in units of symbol time of the received signal u(n) input to the equalizer.

Also, in order to increase the processing speed, it is preferable that the HIP-RLS estimation apparatus 107 operates in a pipeline configuration that starts to update the equalizer filter coefficient before the termination of generation of the current equalizer filter coefficient.

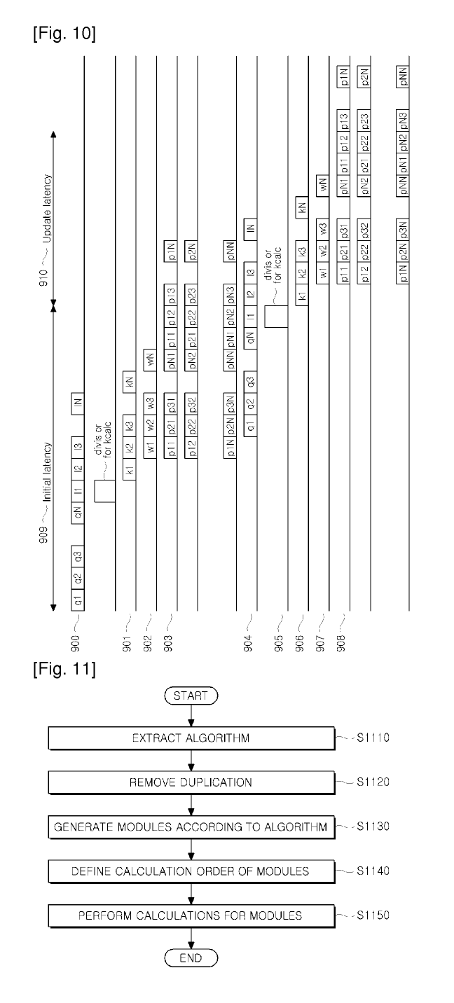

FIG. 10 is a waveform diagram of the HIP-RLS estimation apparatus 107 according to an embodiment of the present invention.

Referring to FIG. 10, reference numerals 900 through 902 denote signals used to generate a signal w(1), reference numerals 903 through 906 denote signals used to generate a signal w(2), and a reference numeral 907 denotes a signal used to generate a signal w(3).

First, the HIP-RLS estimation apparatus 107 generates q(n) and l(n) signals 900 based on an initial P(n) signal P(0) (not illustrated).

Herein, the signal l(n) starts to be generated after completion of generation of the signal q(n), and a k(n) signal 901 starts to be generated from the signal q(n) when the signal l(n) starts to be generated.

Thereafter, the HIP-RLS estimation apparatus 107 generates a w(1) signal 902 with a delay of 1 unit time from the generation of the signal k(n).

Herein, an interval 908 between the signals 900 and 902 is an initial latency 909 necessary for generation of the signal w(1). The generation of a signal q(1) is started before completion of the generation of the signal w(1), to perform an update operation 910 for a w(2) signal 906.

Meanwhile, q1˜qN(900, 904) signals are q1=q(n)[0]˜qN=q(n)[N−1]; l1˜lN(901, 905) signals are l1=l(n)[0]˜lN=l(n)[N−1]; k1˜kN(902, 906) signals are k1==k(n)[0]˜kN=k(n)[N−1]; w1˜wN(903, 907) signals are w1=w(n)[0]˜wN=w(n)[N−1]; and p11˜pNN(904, 908) signals are p11=p[0][0]˜pNN=p[N−1][N−1].

As illustrated in FIG. 10, the HIP-RLS estimation apparatus 107 operates in a pipeline configuration, thereby providing miniaturization and high-speed signal processing because of low area complexity.

Table 1 and Table 2 show the comparison between the performance of a CORDIC-based RLS estimation apparatus and the performance of the HIP-RLS estimation apparatus 107 when the order of the estimation apparatuses is 9. Table 1 shows a comparison between the area complexity of the CORDIC-based RLS estimation apparatus and the area complexity of the HIP-RLS estimation apparatus 107. Table 2 shows a comparison between the signal processing speed of the CORDIC-based RLS estimation apparatus and the signal processing speed of the HIP-RLS estimation apparatus 107.

In Table 1, the area complexity is expressed as the number of slices that are the units of a logic gate device. It can be seen from Table 1 that the HIP-RLS estimation apparatus 107 has only about 40% of the area complexity of the CORDIC-based RLS estimation apparatus.

TABLE 1

| | Area complexity |
|---|---|
| Estimation apparatus type | (Number of slices) |
| HIP-RLS | 17784 |
| CORDIC-based RLS | 44928 |

Thus, the use of the HIP-RLS estimation apparatus 107 can reduce the chip size by about 40% and thus can fabricate about 2.5 times more ships using the same wafer, thereby reducing the unit cost.

Also, it can be seen from Table 2 that the HIP-RLS estimation apparatus 107 requires only about 5% of the signal processing time of the CORDIC-based RLS estimation apparatus.

TABLE 2

| Estimation apparatus type | Signal processing time |
|---|---|
| HIP-RLS | 4.82 μsec |
| CORDIC-based RLS | 5.1 μsec |

FIG. 11 is a flowchart illustrating a method for estimating a wireless signal according to an embodiment of the present invention.

Referring to FIG. 11, in operation S1110, the estimation method models an RX signal estimation scheme according the characteristics of an equalizer and extracts a suitable algorithm.

In operation S1120, the estimation method removes duplication from the extracted algorithm in order to provide the optimal operation of the algorithm.

In operation S1130, the estimation method converts the duplication-removed algorithm into one or modules by applying the criterion of one of a function and an operation.

In operation S1140, the estimation method extracts a correlation between the one or more modules to define a calculation order suitable for the execution of the algorithm.

In operation S1150, the estimation method performs calculations for the respective modules according to the defined calculation order to determine the equalizer filter coefficients according to the characteristics of the RX signal, thereby estimating the RX signal and equalizer error.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

1. An apparatus for estimating high-integration, high-speed and pipelined Recursive Least Squares (RLSs), the apparatus comprising:
a first block for outputting an estimation error signal, a second internal signal and a third internal signal based on a first internal signal, a reference signal, an observed signal and an equalizer output signal received from the outside;
a second block for generating a fourth internal signal based on the observed signal and the second internal signal output from the first block;
a third block for updating an equalizer filter coefficient based on the estimation error signal output from the first block and the fourth internal signal output from the second block; and
a fourth block for updating the first internal signal based on the third internal signal output from the first block and the fourth internal signal output from the second block,
wherein the first through fourth internal signals are calculated through an RLS algorithm having a connection structure without a duplicate operation.

2. The apparatus of claim 1, wherein the first block comprises a second internal signal generator and a third internal signal generator for respectively generating the second internal signal and the third internal signal based on the first internal signal and the observed signal.

3. The apparatus of claim 2, wherein the second internal signal generator comprises:
a plurality of multipliers for multiplying a plurality of the sequentially-input first internal signals by the observed signals of the corresponding orders; and
at least one adder for summing the outputs of the multipliers to output the resulting signals sequentially,
wherein the second internal signal is generated by applying a predetermined forgetting factor to the output of the adder.

4. The apparatus of claim 2, wherein the third internal signal generator comprises:
a plurality of multipliers for multiplying the conjugate complex values of a plurality of the sequentially-input first internal signals by the observed signals of the corresponding orders; and
at least one adder for summing the outputs of the multipliers to output the resulting signals sequentially,
wherein the third internal signal is generated by applying a predetermined forgetting factor to the output of the adder.

5. The apparatus of claim 1, wherein the first block generates the estimation error signal by subtracting the reference signal from the output signal.

6. The apparatus of claim 1, wherein the second block generates the fourth internal signal on the basis of the second internal signal and the observed signal by using the following equation:
$$k = \frac{q}{1 + real ( {\overline{u}}^{H} ( n ) q )}$$
where k is the fourth internal signal, q is the second internal signal, and
ū(n)
is the observed signal.

7. The apparatus of claim 1, wherein the third block calculates the updated value of the equalizer filter coefficient on the basis of the estimation error signal and the fourth internal signal by using the following equation:
w(n+1)=w(n)+k*e(n)
where w(n) is the equalizer filter coefficient, e(n) is the estimation error signal, and k is the fourth internal signal.

8. The apparatus of claim 1, wherein the fourth block comprises:
a memory module for storing the first internal signal;
a multiplier for multiplying a forgetting factor to the current first internal signal output from the memory module;
a Hermite operation unit for multiplying the fourth internal signal by the Hermite transform value of the third internal signal; and
an adder for subtracting the output of the Hermite operation unit from the output of the multiplier,
wherein the first internal signal is updated into the output of the adder.

9. The apparatus of claim 8, wherein the memory module comprises at least two bank memories to perform selective input/output in a switching configuration.

10. The apparatus of claim 8, wherein the Hermite operation unit comprises a plurality of multipliers for respectively multiplying the sequentially-input fourth internal signals by the Hermite transform values of the third internal signals to output the resulting signals sequentially.

11. A method for estimating high-integration, high-speed and pipelined Recursive Least Squares (RLSs), the method comprising:
externally receiving a reference signal, an observed signal and an equalizer output signal from the outside;
outputting an estimation error signal, a second internal signal and a third internal signal based on the first internal signal, the reference signal, the observed signal and the equalizer output signal;
outputting a fourth internal signal based on the observed signal and the second internal signal;
updating an equalizer filter coefficient based on the estimation error signal and the fourth internal signal; and
updating the first internal signal based on the third internal signal and the fourth internal signal.

12. The method of claim 11, wherein the operations of claim 11 are repeated in units of symbols of an RX signal input to the equalizer.

13. The method of claim 11, wherein the updating of the equalizer filter coefficient is performed in a pipeline configuration that updates the equalizer filter coefficient before the termination of generation of the current equalizer filter coefficient.

14. The method of claim 11, wherein the estimation error signal in the outputting of the second internal signal and the third internal signal is generated by subtracting the reference signal from the output signal.

15. The method of claim 11, wherein the outputting of the second internal signal comprises:
multiplying a plurality of the sequentially-input first internal signals by the observed signals of the corresponding orders;
summing the multiplication results; and
applying a predetermined forgetting factor to the summing results to generate the second internal signal.

16. The method of claim 11, wherein the outputting of the third internal signal comprises:
multiplying the conjugate complex values of a plurality of the sequentially-input first internal signals by the observed signals of the corresponding orders;
summing the multiplication results; and
applying a predetermined forgetting factor to the summing results to generate the third internal signal.

17. The method of claim 11, wherein the outputting of the fourth internal signal comprises generating the fourth internal signal on the basis of the second internal signal and the observed signal by using the following equation:
$$k = \frac{q}{1 + real ( {\overline{u}}^{H} ( n ) q )}$$
where k is the fourth internal signal, q is the second internal signal, and
ū(n)
is the observed signal.

18. The method of claim 11, wherein the updating of the equalizer filter coefficient comprises generating the next equalizer filter coefficient on the basis of the estimation error signal and the fourth internal signal by using the following equation:
w(n+1)=w(n)+k*e(n)
where w(n) is the equalizer filter coefficient, e(n) is the estimation error signal, and k is the fourth internal signal.

19. The method of claim 11, wherein the updating of the first internal signal comprises:
multiplying a forgetting factor to the current first internal signal;
multiplying the fourth internal signal by a Hermite transform value of the third internal signal; and
subtracting the product of the fourth internal signal and the Hermite transform value from the product of the forgetting factor and the current first internal signal to generate the first internal signal.

20. A method for estimating a wireless signal, comprising:
modeling a signal estimation scheme to extract an algorithm;
removing duplication from the algorithm;
converting the duplication-removed algorithm into one or more modules;
extracting a correlation between the modules to define a calculation order; and
performing calculations for the respective modules according to the defined calculation order.
